(19) United States
(12) Patent Application Publication
(10) Pub. No.: US 2010/0170697 A1
(43) Pub. Date: Jul. 8, 2010

(54) SIGNAL WIRE

(76) Inventor: Rosa CHANG, Taipei (TW)

Correspondence Address: Muncy, Geissler, Olds & Lowe, PLLC, 4000 Legato Road, Suite 310, FAIRFAX, VA, 22033, US

(21) Appl. No.: 12/410,196

(22) Filed: Mar. 24, 2009

(30) Foreign Application Priority Data
Jan. 5, 2009 (CN) 200920001601.9

(51) Int. Cl. H01B 5/08

(52) U.S. Cl. 174/128.2

(57) ABSTRACT

A signal wire which at least comprises a flexible core and a metal layer is disclosed. The flexible core has a surface and a longitudinal direction, and the metal layer comprises a plurality of metal foil straps. The metal foil straps are directly and helically wound in parallel on the surface of the core to form a continuously, electrically conductive structure along the longitudinal direction. Thereby, the signal wire has both a decreased external diameter and decreased impedance.

This application claims priority to China Patent Application No. 200920001601.9 filed on Jan. 5, 2009.

### CROSS-REFERENCES TO RELATED APPLICATIONS

Not applicable.

### BACKGROUND OF THE INVENTION

1. Field of the Invention

The present invention relates to a signal wire, and more particularly, to a signal wire capable of enduring repeated bending.

2. Descriptions of the Related Art

Various technical products, such as electronic product connections, stereo equipment, loudspeakers, earphone audio cables, and even precise medical appliances (e.g., hearing aids), must all transmit signals via signal wires. Because the transmission efficiency of the signal wires has an influence on the definition of the signals and the thickness in terms of the external diameter thereof also has an influence on the products' minuteness, the quality of the signal wires should be improved. Common conventional solid signal wires used in environments where repeated bending is expected, such as electronic product connections, stereo equipment, loudspeakers, vibrating instruments and audio cables, often are fatigued or fractured due to frequent vibration or bending.

To solve the above problem with the solid signal wires, a conventional solution is to use flexible fibers in the signal wires to enhance the tolerance to repeated bending. A conventional signal wire 1 is depicted in FIGS. 1 and 2. FIG. 2 is drawn on an exaggerated scale to show the profile of the individual metal foil straps 112 more clearly. In application, the metal foil straps 112 may not have a gap therebetween and may even overlap with each other. The conventional signal wire 1 comprises at least one metal foil wire 11, each of which comprises a flexible fiber bundle 111 formed of a plurality of flexible fibers and a metal foil strap 112. Each of the metal foil straps 112 is helically wound on a surface of the corresponding flexible fiber bundle 111 to form the corresponding metal foil wire 11. This remarkably improves the tolerance of the signal wire 1 to repeated bending, making it suitable for use in environments such as stereo equipment, loudspeakers, vibrating instruments and audio cables. However, when signals are transmitted among the metal foil wires 11, it is usually difficult for the signals to overcome the surface resistance that arises when the wound metal foil straps 112 come into contact with each other to propagate along a longitudinal direction of each metal foil wire 11 directly. Hence, the signals mainly propagate helically along the direction in which each metal foil strap 112 is wound, which renders the signal transmission path longer. Consequently, the impedance of each of the metal foil wires 11 is higher than that of a solid signal wire with an identical metal material cross section area. To overcome the problem of high impedance, the conventional signal wire 1 increases the number of metal foil wires 11 thereof to improve the transmission efficiency and decrease the impedance. As shown in FIGS. 1 and 2, the conventional signal wire 1 comprises seven metal foil wires 11. However, increasing the number of metal foil wires 11 leads to a thicker external diameter of the convention signal wire 1, making it unsuitable for use in minute instruments such as hearing aids.

Accordingly, it is important to provide a signal wire with a small external diameter, a low impedance, and is capable of enduring repeated bending.

### SUMMARY OF THE INVENTION

One objective of this invention is to provide a signal wire with a small external diameter that is capable of enduring repeated bending. This signal wire is adapted for minute instruments.

Another objective of this invention is to provide a signal wire capable of enduring repeated bending with low impedance to enhance the transmission efficiency thereof.

This invention provides a signal wire comprising a flexible core and a first metal layer. The flexible core has a surface and a longitudinal direction, while the first metal layer comprises a plurality of metal foil straps. The metal foil straps are directly and helically wound in parallel on the surface of the core to form a continuously, electrically conductive structure along the longitudinal direction.

The signal wire comprises a second metal layer, wherein the second metal layer comprises a plurality of metal foil straps, and the metal foil straps are directly and helically wound in parallel on the surface of the first metal layer to form a continuously, electrically conductive structure along the longitudinal direction.

The first metal layer comprises five to eight metal foil straps.

Each of the metal foil straps of the first metal layer has a width substantially between 0.1 mm and 0.3 mm.

Each of the metal foil straps of the first metal layer has a thickness substantially between 0.02 mm and 0.05 mm.

The metal foil straps of the first metal layer are a plurality of copper foil straps.

The second metal layer comprises five to eight metal foil straps.

Each of the metal foil straps of the second metal layer has a width substantially between 0.1 mm and 0.3 mm.

Each of the metal foil straps of the second metal layer has a thickness substantially between 0.02 mm and 0.05 mm.

The metal foil straps of the second metal layer are a plurality of copper foil straps.

The core has an external diameter substantially between 0.1 mm and 0.5 mm.

The core is a flexible fiber bundle.

The core is a metal foil wire comprising a flexible fiber bundle and a metal foil strap, and the metal foil strap is directly and helically wound on the surface of the flexible fiber bundle.

Thereby, as compared to the conventional technology, the signal wire can have a significantly decreased external diameter while still having relatively low impedance to make it suitable for use in minute instruments. The flexibility of the signal wire can improve the bending tolerance of the signal wire so that no break or fracture will occur to the signal wire even when it is repeatedly bent in use. Moreover, this invention may further simplify the production procedure, speed up the production process and lower the production cost.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a conventional signal wire;

FIG. 2 is a cross-sectional view of the conventional signal wire;

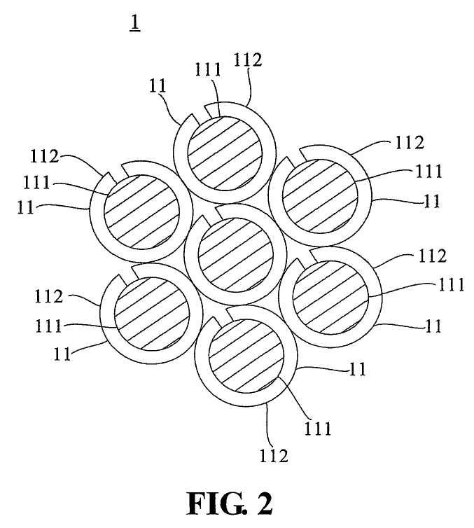

FIG. 3 is a schematic view of a signal wire according to an embodiment of this invention; and

FIG. 4 is a cross-sectional view of a signal wire according to an embodiment of this invention.

### DESCRIPTION OF THE PREFERRED EMBODIMENT

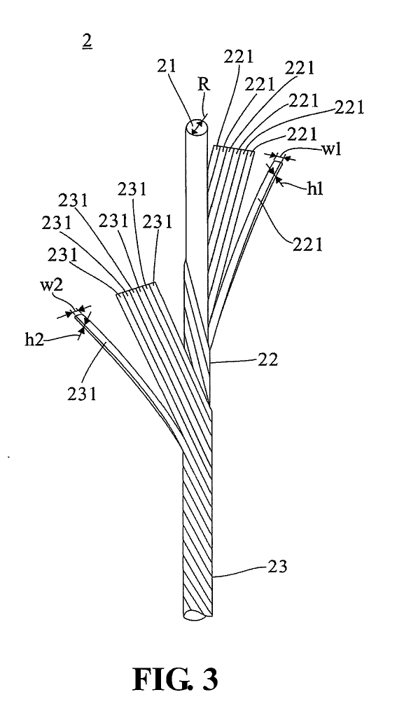

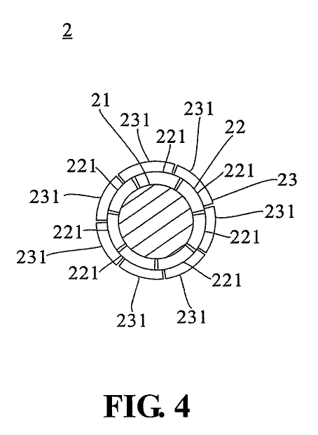

A signal wire 2 according to an embodiment of this invention is depicted in FIGS. 3 and 4. FIG. 4 is drawn on an exaggerated scale to show the profile of individual metal foil straps 221 and 231 more clearly; and it shall be appreciated that in practical use, the metal foil straps 221 and 231 may not have a gap therebetween and may even overlap with each other. The signal wire 2 of this embodiment at least comprises a flexible core 21 and a first metal layer 22. The flexible core 21 has a surface and a longitudinal direction, while the first metal layer 22 comprises a plurality of metal foil straps 221. The metal foil straps 221 of the first metal layer 22 are directly and helically wound in parallel, but not overlapped with each other, on the surface of the core 21 to form a continuously, electrically conductive structure along the longitudinal direction. The signal wire 2 of this invention comprises only a single core 21 which has an external diameter R approximately equal to or slightly greater than that of the flexible fiber bundle 111 of the conventional signal wire 1, so the overall external diameter of the signal wire 2 is remarkably reduced.

Because the metal foil straps 221 are helically wound on the surface of the core 21 in parallel, the number of wound turns and the practical length of each metal foil strap 221 are decreased compared to the conventional solution for the same signal wire length. In this way, the signal transmission path in each metal foil strap 221 is decreased in length, making the impedance of each metal foil strap 221 in the present signal wire 2 lower than that of the metal foil wires 11 of the conventional signal wire 1. Thereby, the external diameter of the signal wire 2 may be decreased remarkably while the impedance thereof is still equal to or even less than that of the conventional signal wire 1, making it suitable for use in minute instruments. Furthermore, the signal wire 2 of this invention comprises only a single core 21, so when a decreased impedance is desired, it is only necessary to increase the number of metal foil straps 221 and helically wind all the metal foil straps 221 in parallel on the surface of the core 21 directly without increasing the overall external diameter of the signal wire 2. In application, the first metal layer 22 of this invention should comprise five to eight metal foil straps 221. For example, as shown in FIGS. 3 and 4, the first metal layer 22 comprises seven metal foil straps 221. However, in other examples, the first metal layer 22 may also comprise a different number of metal foil straps 221 depending on the practical requirements, magnitude of the signal current and the external diameter R of the core 21. The thicker the external diameter R of the core 21, the larger the number of metal foil straps 221 in the first metal layer 22.

To further decrease the impedance of the signal wire 2 while still keeping the external diameter thereof to be smaller than that of the conventional signal wire 1, the signal wire 2, as shown in FIGS. 3 and 4, may optionally comprise a second metal layer 23, or even comprise a plurality of other metal layers sequentially coated on the first metal layer 22. The second metal layer 23 also comprises a plurality of metal foil straps 231, which are directly and helically wound in parallel but not overlapping each other on the surface of the first metal layer 22 to form a continuously, electrically conductive structure along the longitudinal direction of the core 21. In application, the second metal layer 23 of this invention comprises five to eight metal foil straps 231 in parallel to each other; for example, as shown in FIGS. 3 and 4, the second metal layer 23 comprises seven metal foil straps 231. It shall be noted that, depending on the magnitude of the signal current and the external diameter R of the core 21, those of ordinary skill in the art may readily devise other numbers of metal layers in the signal wire 2 or other numbers of metal foil straps 221, 231 included in the first metal layer 22 or the second metal layer 23. The thicker the external diameter R of the core 21, the larger the numbers of metal foil straps 221, 231 included in the first metal layer 22 and the second metal layer 23.

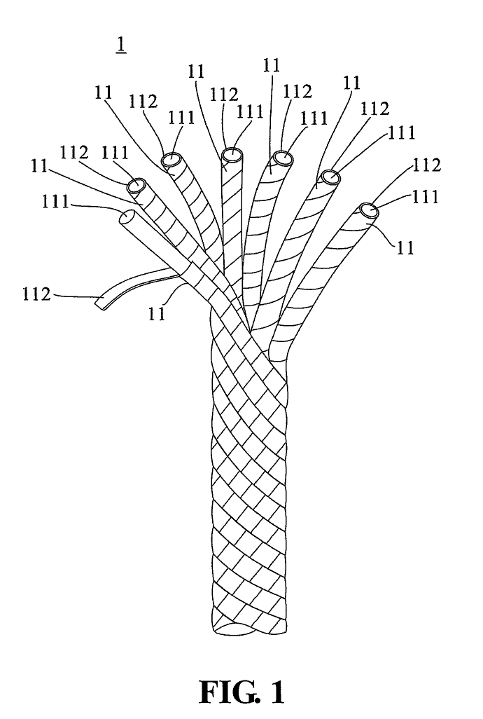

The preferred materials of the core 21, the first metal layer 22 and the second metal layer 23 of this invention will now be described in detail. The core 21 of this invention may be a flexible fiber bundle comprising a plurality of flexible fibers. Alternatively, the core 21 of this invention may be a conventional metal foil wire 11 comprising a flexible fiber bundle 111 and a metal foil strap 112, as shown in FIG. 1. The metal foil strap 112 is also directly and helically wound to a surface of the flexible fiber bundle 111. The flexible fibers helps to improve the bending tolerance of the core 21 and consequently of the signal wire 2 as a whole, so that the signal wire 2 can be used in electronic product connections, stereo equipment, loudspeakers, vibrating instruments, audio cables or even minute medical appliances (e.g., hearing aids) without being broken or fractured. However, the core 21 of this invention is not limited to the above materials, and other flexible materials that can endure repeated bending may also be applicable to the core 21.

The metal foil straps 221 of the first metal layer 22, the metal foil straps 231 of the second metal layer 23, and even the metal foil straps 112 of the metal foil wire 11 that may be used as the core 21, should all be copper foil straps to decrease the impedance and improve signal conductivity of the signal wire 2. However, the metal foil straps 221 of the first metal layer 22 and the metal foil straps 231 of the second metal layer 23 are not limited to copper foil straps, but may also be made of other materials with good conductivity.

As shown in FIG. 3, the preferred dimensions of the core 21, the first metal layer 22 and the second metal layer 23 of this invention will now be described in detail. The core 21 of this invention should have an external diameter R ranging substantially between 0.1 mm and 0.5 mm. Each of the metal foil straps 221 of the first metal layer 22 has a width w1 and a thickness h1. The width w1 should range substantially between 0.1 mm and 0.3 mm, and the thickness h1 should range substantially between 0.02 mm and 0.05 mm. Also, each of the metal foil straps 231 of the second metal layer 23 has a width w2 and a thickness h2. The width w2 should range also substantially between 0.1 mm and 0.3 mm, and the thickness h2 should range between 0.02 mm and 0.05 mm. The external diameter R of the core 21, the width w1 and thickness h1 of the metal foil straps 221 of the first metal layer 22, and the width w2 and thickness h2 of the metal foil straps 231 of the second metal layer 23 described above are not merely limited to the aforesaid dimensional values, but may be adjusted flexibly depending on the magnitude of the signal current and required dimensional limitations of the device where this invention is used. This renders the signal wire 2 widely applicable in various products.

According to the above descriptions, by directly and helically winding a plurality of metal foil straps in parallel on the surface of the core, the signal wire of this invention presents a smaller external diameter, lower impedance and improved tolerance to repeated bending as compared to conventional signal wires. The structure of the signal wire also allows for a simplified production procedure, reduced energy waste and an increased production speed, thereby lowering the production cost. Furthermore, the signal wire may be flexibly adjusted in dimensions depending on the different magnitudes of the signal current, which renders it widely applicable in various products.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A signal wire, comprising:
a flexible core having a surface and a longitudinal direction; and
a first metal layer comprising a plurality of metal foil straps, wherein the metal foil straps are directly and helically wound in parallel on the surface of the core to form a continuously, electrically conductive structure along the longitudinal direction.

2. The signal wire as claimed in claim 1, wherein the signal wire comprises a second metal layer, the second metal layer comprises a plurality of metal foil straps, and the metal foil straps are directly and helically wound in parallel on a surface of the first metal layer to form a continuously, electrically conductive structure along the longitudinal direction.

3. The signal wire as claimed in claim 1, wherein the first metal layer comprises five to eight metal foil straps.

4. The signal wire as claimed in claim 1, wherein each of the metal foil straps of the first metal layer has a width substantially between 0.1 and 0.3 mm.

5. The signal wire as claimed in claim 1, wherein each of the metal foil straps of the first metal layer has a thickness substantially between 0.02 and 0.05 mm.

6. The signal wire as claimed in claim 1, wherein the metal foil straps of the first metal layer are copper foil straps.

7. The signal wire as claimed in claim 2, wherein the second metal layer comprises five to eight metal foil straps.

8. The signal wire as claimed in claim 2, wherein each of the metal foil straps of the second metal layer has a width substantially between 0.1 and 0.3 mm.

9. The signal wire as claimed in claim 2, wherein each of the metal foil straps of the second metal layer has a thickness substantially between 0.02 and 0.05 mm.

10. The signal wire as claimed in claim 2, wherein the metal foil straps of the second metal layer are copper foil straps.

11. The signal wire as claimed in claim 1, wherein the core has an external diameter substantially between 0.1 and 0.5 mm.

12. The signal wire as claimed in claim 1, wherein the core is a flexible fiber bundle.

13. The signal wire as claimed in claim 1, wherein the core is a metal foil wire comprising a flexible fiber bundle and a metal foil strap, and the metal foil strap is directly and helically wound on the surface of the flexible fiber bundle.
